(19) United States
(12) Patent Application Publication
(10) Pub. No.: US 2010/0271747 A1
(43) Pub. Date: Oct. 28, 2010

(54) Capacitor having features of heat dissipation and of energy conservation

(75) Inventors: Ching Feng Lin, Miaoli (TW); Ming Tsung Chen, Miaoli (TW)

Correspondence Address: BACON & THOMAS, PLLC, 625 SLATERS LANE, FOURTH FLOOR, ALEXANDRIA, VA, 22314-1176, US

(73) Assignee: APAQ TECHNOLOGY CO., LTD., Mialoi (TW)

(21) Appl. No.: 12/591,018

(22) Filed: Nov. 5, 2009

(30) Foreign Application Priority Data
Apr. 24, 2009 (TW) 098206884

(51) Int. Cl. H01G 2/08; H01G 4/258; H01G 9/145; H01G 9/08

(52) U.S. Cl. 361/274.1; 361/535; 361/517; 361/502

(57) ABSTRACT

A capacitor that has the features of heat dissipation and energy conservation comprises a capacitor core, an aluminum shell surrounding the capacitor core, the aluminum shell is covered with rubber that completely covers the top of the capacitor core, then with the use of an extruding machine, the upper orifice of the aluminum shell is extruded and sealed up around the rubber completely; the outer surface of the aluminum is formed with an aluminum oxidized insulating layer after the aluminum shell is processed through an aluminum metal surface transformation treatment, since the aluminum shell is not covered with plastic film (or sleeve), heat dissipation is enhanced; in addition, since plastic film or sleeve is not used, no pollution is occurred, and hence more friendly to the environment; furthermore, since heat generation is low, energy is conserved.

### BACKGROUND OF THE INVENTION

1. Field of the Invention

The present invention relates to a capacitor that has the features of heat dissipation and of energy conservation, in particular, the features are derived from a capacitor that has the following constructions: (1) the surface of the aluminum shell is processed with aluminum metal surface transformation treatment, which allows the aluminum shell having better heat dissipation and radiating color, in addition, having improved heat dissipation, the capacitor is more reliable; (2) the aluminum shell is not covered with plastic film or sleeve, hence there is no additional cover of plastic film or sleeve that causes pollution to the environment; furthermore, since the heat generation is low, energy is better conserved.

2. Description of Prior Art

A capacitor, depending on its application, may be categorized as electrolytic capacitor or non-electrolytic capacitor; the electrolytic capacitor may be further categorized as aluminum based electrolytic capacitor or tantalum based electrolytic capacitor depending on the material used; and furthermore, the aluminum based electrolytic capacitor may be categorized as the winding or stacking type which depends on the structural formation of the capacitor's core component. Traditional aluminum electrolytic capacitor uses high-purity aluminum foil as the anode which is etched, and the dielectric layer is a topical thin film that has been formed by anodic oxidation. Between the cathode foil and the anode foil there is an insulating layer of either a thin paper or a cloth membrane, and the electrolyte is absorbed by this layer of either thin paper or cloth membrane. On the other hand, the material used as insulating layer for the solid electrolytic capacitor is mainly either any kind of non-woven fiber cloth or carbonized paper.

As shown in FIG. 1, the production of the above mentioned aluminum electrolytic capacitor is as follows: first, establish anode foil 11, the surface of the anode foil 11 is a dielectric layer that is in the form of an oxidized film, the anode head wire 12 is extended from one end of the anode foil 11; next, fabricate the cathode foil 13 by aluminum material, the cathode lead wire 14 is extended from one end of the cathode foil 13; lastly, an insulating layer 15 is placed between the anode foil 11 and the cathode foil 13, and then, the three layers are rolled up to form the capacitor core 16 of a winding type.

During production, the core 16 is baked for 60˜180 minutes at a temperature of 130˜300° C., so as to carbonize the insulating layer; the core 16 is then placed in 2˜10% ammonium adipate solution at a temperature of 60˜90° C. for 10˜60 minutes, this process is to electrochemically oxidize the core; the processed core 16 is then submerged into the liquid having mixture of organic monomer and oxidant under normal atmospheric pressure for 10˜40 minutes at a temperature of 20˜35° C.; finally the core 16 is taken out for polymerization under normal atmospheric pressure. After having gone through the above processes for 0.5˜6 hours at the temperature between 30˜300° C., the core 16 is transformed into a highly conductive organic polymer.

During assembly, as shown in FIG. 2, the core 16 of the capacitor is placed into an aluminum shell 2, and it is then covered with rubber 21. There are two through holes that are formed in advance at the volume of the rubber 21 in the position that is corresponded to where the two conducting wires 12, 14 are to be inserted through; after the conducting wires 12, 14 are inserted through the rubber 21, the bottom parts 17, 18 of the wires 12, 14 (located beneath the rubber 21) block the two through holes. By using extruding machine, the upper opening of the aluminum shell 2 is extruded until it is enclosed perfectly and sealed up around the rubber 21. For the final stage of the assembly, the sealed electrolytic capacitor goes through an aging process at a temperature of 105˜145° C. for 0.5˜10 hours. Then the production of a Dip-type solid electrolytic capacitor is completed.

The problem of the above aluminum solid electrolytic capacitor is that: at the outer layer of the aluminum shell 2 there is usually a plastic film 20 (or sleeve), as shown in FIG. 3, this composition has poor heat dissipation, and it also lowers the capacitor's working efficiency (i.e. high energy consumption), in addition, because of the poor heat dissipation, service life of the capacitor is greatly affected. Another disadvantage of the traditional capacitor is that it is difficult to distinguish capacitors that are to be used for different specifications, since the aluminum shell of the various capacitors have the same color, it is difficult to separate the different capacitors judging from their external appearances, therefore, this may cause misuse of capacitors for their respective applications.

### SUMMARY OF THE INVENTION

In view of the deficiencies found in prior art, the inventor has dedicated great efforts for years in studying and in acquiring skills for improving these deficiencies and comes up with a novel capacitor capable of heat dissipation and energy conservation as provided for in this invention.

The main objective of present invention is to provide a capacitor that has the features of heat dissipation and energy conservation. The heat dissipation feature is derived mainly from the specific construction of the capacitor in that: an aluminum shell, the surface of which is processed using aluminum metal surface transformation treatment and therefore, the surface becomes an insulating layer that is made from aluminum oxidized compound; since the aluminum shell is not covered with plastic film or sleeve, it enhances heat dissipation. In addition, without the use of plastic film or sleeve, there is less pollution to the environment and therefore it is more friendly to the environment. Furthermore, with low heat generation, energy is conserved.

A second objective of present invention is to provide a capacitor that has the features of heat dissipation and energy conservation mainly in that, the introduction of the use of anodic treatment, soaking and staining treatment, or other surface transformation treatments to the aluminum shell of the electrolytic capacitor of present invention enable the electrolytic capacitor of present invention to radiate different colors for identification purpose. Therefore, a uniformed treatment process standardizes the incorporation of color identification for capacitors, and the standardization induces ease of production and at the same time lowers costs of production.

A third objective of present invention is to provide a capacitor that has the features of heat dissipation and energy conservation by introduction of color distinction associating with different capacitors. For quality control purpose, colored capacitors help assemblers to easily identify whether the correct capacitors are installed in respect to their corresponding electric circuit panels. Therefore, colored capacitors significantly reduce the extent of faulty or mismatched component installation. In addition, colored capacitors may be incorporated into industrial designs to enhance products' artistic designs and appearances.

A fourth objective of present invention is to provide a capacitor having the features of heat dissipation and of energy conservation by the flexibility of the thickness of the insulating layer that is used with specific capacitor. The thickness used depends upon a capacitor's voltage specification, that is, a capacitor with high voltage specification may use thicker insulating layer, while the capacitor with low voltage specification may use thinner insulating layer.

Bearing the above objectives, the capacitor of present invention is equipped with a capacitor core placed in an aluminum shell, the aluminum shell is covered with rubber, and the rubber completely covers the top of the capacitor core, by using of extruding machine, the orifice of aluminum shell is extruded and sealed up around the rubber completely; this aluminum shell contains an aluminum oxidized insulating layer after going through the aluminum metal surface transformation treatment and therefore no plastic film (or sleeve) is used. Since the aluminum shell is not covered with plastic film (or sleeve), heat dissipation is enhanced; also, since the aluminum shell is not covered with plastic film or sleeve, it does not cause pollution, and thus is more friendly to environment; furthermore, since the heat generation is low, energy is better conserved.

A more complete understanding of these and other features and advantages of the present invention will become apparent from careful consideration of the following detailed description of certain embodiments illustrated in the accompanying drawings.

### BRIEF DESCRIPTION OF THE DRAWINGS

FIG. 1 is a three-dimensional illustrative view showing a conventional capacitor.

FIG. 2 is a three-dimensional illustrative view showing a conventional capacitor to be placed into an aluminum shell.

FIG. 3 is a cross-sectional view showing part of the conventional capacitor.

FIG. 4 is a three-dimensional illustrative view showing the capacitor of present invention to be placed into an aluminum shell.

FIG. 5A, 5B & 5C are respectively a cross-sectional view showing the capacitor of present invention.

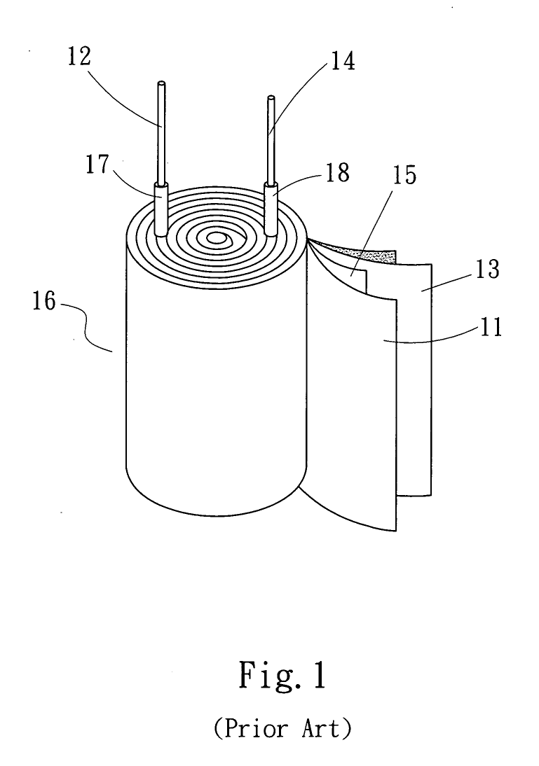

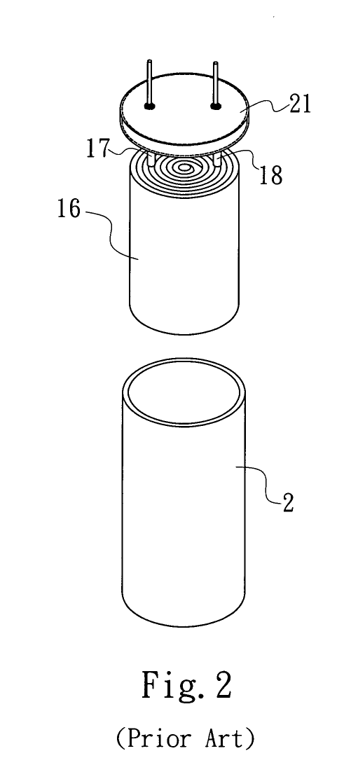

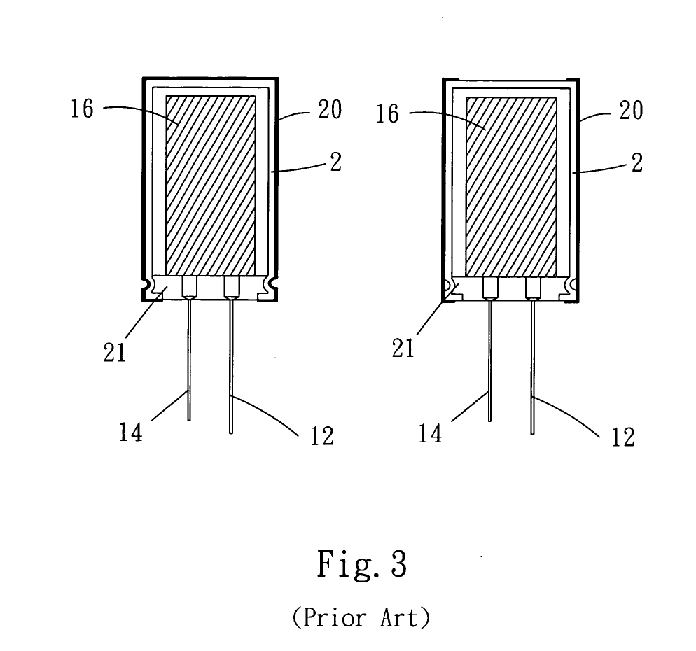

### DETAILED DESCRIPTION OF THE PREFERRED EMBODIMENTS

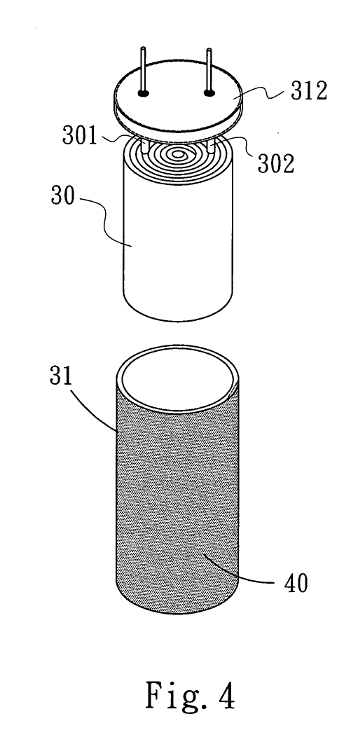

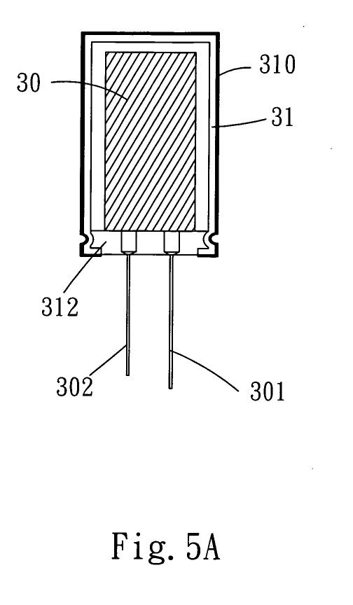

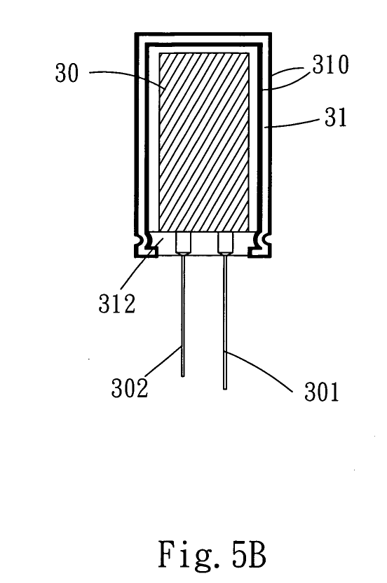

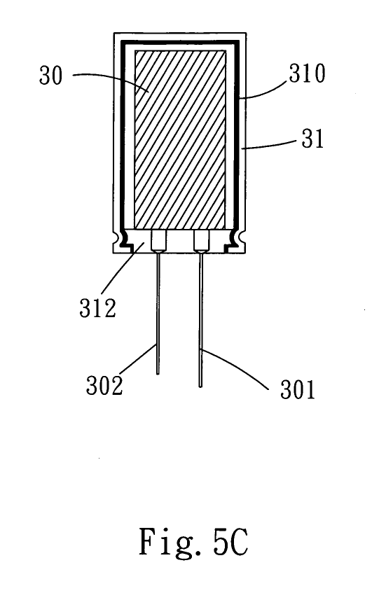

Present invention relates to a capacitor that has the features of heat dissipation and of energy conservation. Referring to FIGS. 4, 5A, 5B, and 5C, the capacitor of present invention comprises of a capacitor core 30, surrounding the capacitor core 30 is an aluminum shell 31, the aluminum shell 31 is filled up with rubber 312 which completely covers the top of the capacitor core 30, then with the use of an extruding machine, the upper orifice of the aluminum shell 31 is extruded and sealed up around the rubber 312 completely; the anode lead 301 and the cathode lead 302 of the capacitor core 30 are made to extend outward for electrical connection.

The outer surface of the aluminum shell 31 has an aluminum oxidized insulating layer 310 after the shell is processed through an aluminum metal surface transformation treatment, as shown in FIGS. 5A, 5B, and 5C, since the aluminum shell 31 is not covered with plastic film (or sleeve), heat dissipation is enhanced; also, since heat generation is low, energy is conserved.

The capacitor core 30 of present invention is similar to that of conventional electrolytic capacitor, it comprises an anode foil, a cathode foil and an insulating layer that is placed between the anode foil and the cathode foil. The anode foil is an electric conductive metallic foil that is formed after etching process, the surface of the anode foil has dielectric film after the surface is processed through anodic oxidation, and an anode lead wire is extended from one end of the anode foil. The cathode foil is formed either with or without etching process and anodic oxidation, a cathode lead wire extend from one end of the cathode foil.

Referring to FIG. 4, with the use of anodic oxidation treatment, or soaking and staining treatment, or other surface transformation treatments, colors 40 or colored patterns may be instituted on the aluminum shell 31, these treatments standardize the incorporation of color identification for capacitors and the standardization induces ease of production and at the same time lower costs of production. These colors 40 may be iron gray, brown, blue, or luminous colors . . . or even combination of colored patterns.

The colors instituted on the aluminum shell 31 enable users to easily distinguish the desired capacitor among a group of varieties of capacitors, and this feature reduces confusion for the users.

The thickness of the insulating layer 310 of the aluminum shell 31 is 1˜200 μm, whereas thickness for the best insulation is 10˜50 μm.

The form and shape of the capacitor of present invention may vary, it may be made as a dip type capacitor, a SMD capacitor (not shown in figs), or any other forms and shapes.

The insulating layer 310 of the aluminum shell 31 may be separately and independently placed onto the exterior surface of the aluminum shell 31.

The insulating layer 310 of the aluminum shell 31 may be separately and independently placed onto the interior surface of the aluminum shell 31.

The insulating layer 310 of the aluminum shell 31 may be separately and independently placed onto both the exterior surface and the interior surface of the aluminum shell 31. It should be noted that having insulating layer 310 on both the interior and exterior surfaces of the aluminum shell 31 may achieve even better insulation and heat dissipation.

The aluminum oxide insulating layer 310 is formed after the surface of the aluminum shell 31 of the capacitor of present invention undergoes aluminum metal surface transformation treatment. The surface transformation occurs directly on the surface of the aluminum shell 31, therefore, unlike those of conventional capacitor, no plastic film (or sleeve) is used at the outer layer of the aluminum shell 31. Since there is no plastic film (or sleeve) covering the aluminum shell, heat dissipation is enhanced. In addition, without the use of plastic film (or sleeve), there is no pollution, and hence it is more friendly to the environmental. Furthermore, since the heat generation is low, energy is conserved.

The thickness of the insulating layer 310 may depend upon the voltage specification of the capacitor, therefore, the capacitor with high voltage specification may use thicker insulating layer, whereas the capacitor with low voltage specification may use thinner insulating layer.

From the above comprehensive illustrations, the present invention of a capacitor that has the features of heat dissipation and energy conservation may be concluded to be one creative configuration never seen before. This idea has not been seen in any published printed matter and there has not been any comparable product available in the market, as such, it is undoubtedly that the present invention has its novelty. In addition, the unique characteristics and the functions of the present invention are far superior to the conventional products, and therefore it is unquestionable that the present invention has more progress than any conventional products. It is then believed that the present invention is the one with progressiveness and meet the requirement of patent application according to the Patent Law.

Although the present invention has been described with a certain degree of particularity, the present disclosure has been made by way of example, changes in details of the original of structure may be made without departing from the spirit hereof.

What is claimed is:

1. A capacitor that has the features of heat dissipation and of energy conservation comprises a winding unit as the core of capacitor, an aluminum shell surrounding the capacitor core, from which an anode lead and a cathode lead extended outward for electrical connection; characterized in that:
the outer surface of the aluminum shell is formed with an aluminum oxide insulating layer after the shell is processed through an aluminum metal surface transformation treatment, since the aluminum shell is not covered with plastic film (or sleeve), heat dissipation is enhanced; in addition, since plastic film (or sleeve) is not used, thus no pollution is occurred, and therefore it is more friendly to the environmental; furthermore, since heat generation is low, energy is conserved.

2. A capacitor that has the features of heat dissipation and of energy conservation as claimed in claim 1, whereas the insulating layer of said aluminum shell is located at the exterior surface of the aluminum shell.

3. A capacitor that has the features of heat dissipation and of energy conservation as claimed in claim 1, whereas the insulating layer of said aluminum shell is located at the interior surface of the aluminum shell.

4. A capacitor that has the features of heat dissipation and of energy conservation as claimed in claim 1, whereas a plurality of insulating layer of said aluminum shell are located at both the exterior surface and the interior surface of the aluminum shell.

5. A capacitor that has the features of heat dissipation and of energy conservation as claimed in claim. 1, whereas the thickness of the insulating layer of said aluminum shell is 1˜200 μm, while the thickness for best insulation is 10˜50 μm.

6. A capacitor that has the features of heat dissipation and of energy conservation as claimed in claim 1, whereas the insulation layer of said aluminum shell is treated with anodic treatment, or soaking and staining treatment, or other surface transformation treatments.

7. A capacitor that has the features of heat dissipation and of energy conservation as claimed in claim 1, whereas the form and shape of said capacitor may vary, it may be made as a Dip-type, or SMD type, or a liquid electrolytic capacitor, or capacitor of other forms and shapes.

8. A capacitor that has the features of heat dissipation and of energy conservation as claimed in claim 1, whereas the thickness of the insulating layer of said capacitor may depends upon the voltage specification of the capacitor, therefore the capacitor with high voltage specification may use thicker insulating layer, while capacitor with low working voltage may use thinner insulating layer.
